(19) United States
(12) Patent Application Publication
(10) Pub. No.: US 2026/0202541 A1
(43) Pub. Date: Jul. 16, 2026

(54) ULTRASONIC SENSOR-BASED NEAR FIELD VIGILANT SYSTEM

(71) Applicant: Valeo Schalter und Sensoren GmbH, Bietigheim-Bissingen (DE)

(72) Inventors: Kiran Cherukumilli, Troy, MI (US); Deep Doshi, Troy, MI (US)

(21) Appl. No.: 19/024,679

(22) Filed: Jan. 16, 2025

(51) Int. Cl. G01S 15/931

(52) U.S. Cl. CPC G01S 15/931

(57) ABSTRACT

A method performed by a controller of a vehicle includes generating and emitting sound signals into an environment around the vehicle using one or more ultrasonic sensors arranged on the vehicle, receiving, at the one or more ultrasonic sensors, the sound signals as reflected back toward the vehicle by at least one object in the environment, calculating, at the controller, a threat score associated with the at least one object based on a distance of the object from the vehicle, a velocity of the object, and a direction of movement of the object relative to the vehicle, comparing, at the controller, the threat score to at least one threshold, and generating, at the controller, an alert in response to a determination that the threat score is greater than the at least one threshold.

### TECHNICAL FIELD

The present disclosure relates to systems and methods for using ultrasonic sensors to monitor vehicle surroundings when the vehicle is turned off.

### BACKGROUND

To enhance safety and security, vehicles may be equipped with various features to monitor the environment around the vehicle, such as by capturing and recording images of the environment. In some examples, these features use external cameras to monitor the environment when the vehicle is parked, saving the captured images to a USB drive for later viewing. However, the cameras often start recording when people simply walk by, even if there is no threat. These false alarms lead to unnecessary vehicle power consumption.

### SUMMARY

A method performed by a controller of a vehicle includes generating and emitting sound signals into an environment around the vehicle using one or more ultrasonic sensors arranged on the vehicle, receiving, at the one or more ultrasonic sensors, the sound signals as reflected back toward the vehicle by at least one object in the environment, calculating, at the controller, a threat score associated with the at least one object based on a distance of the object from the vehicle, a velocity of the object, and a direction of movement of the object relative to the vehicle, comparing, at the controller, the threat score to at least one threshold, and generating, at the controller, an alert in response to a determination that the threat score is greater than the at least one threshold.

In an embodiment, a system is configured to perform functions corresponding to steps of any method described herein.

In an embodiment, a tangible, non-transitory computer-readable medium stores instructions that, when executed, cause a processing device to perform any operation of any method disclosed herein.

In an embodiment, a system includes a memory device storing instructions and a processing device communicatively coupled to the memory device. The processing device executes the instructions to perform any operation of any method disclosed herein.

Other technical features may be readily apparent to one skilled in the art from the following figures, descriptions, and claims.

### BRIEF DESCRIPTION OF THE DRAWINGS

FIG. 1A illustrates a schematic of an example vehicle, shown from a top view, according to the present disclosure.

FIG. 1B shows an example system configured to monitor the surroundings of the vehicle using ultrasonic sensors according to the present disclosure.

FIG. 2 shows an example occupancy grid map according to the present disclosure.

FIG. 3 illustrates a block diagram of a computer or computing system according to the present disclosure.

FIG. 4 illustrates steps of an example method for monitoring vehicle surroundings using ultrasonic sensors according to the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Some automotive vehicles may be equipped with a system that monitors the surroundings of the vehicle while parked, turned off, etc. and records images of the surroundings. Such a system enhances the safety and security of a vehicle by using external cameras and sensors for monitoring the environment. The captured images may be stored for later viewing. However, the cameras often start recording when people simply walk by, even if there is no threat. These false alarms lead to unnecessary vehicle power consumption. Further, this and other example systems do not assess the risk of the environment around a parked vehicle. Thus, these systems can command excessive vehicle power consumption due to the cameras actively recording unnecessarily.

Systems and methods according to the present disclosure are configured to provide low cost, low energy consumption monitoring techniques by implementing ultrasonic sensor technology to monitor vehicle surroundings (e.g., when the vehicle is parked, off, unattended or unoccupied, etc.). As used herein, “unattended” or “unoccupied” may correspond to a determination that no individuals are within the vehicle and/or the owner/driver is not within a predetermined distance of the vehicle.

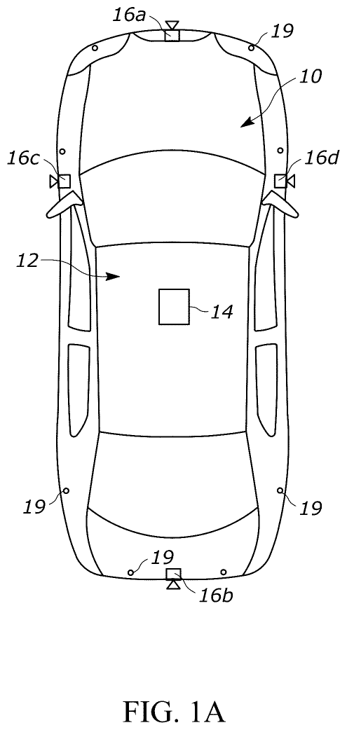

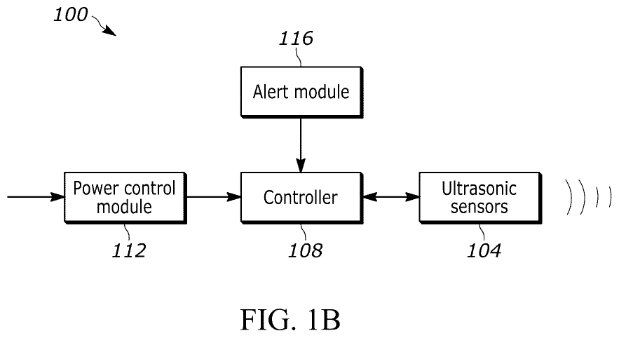

FIG. 1A illustrates a schematic of a vehicle 10 according to an embodiment, shown here from a top view. The vehicle 10 is a passenger car, but can be other types of vehicles such as a truck, van, or sports utility vehicle (SUV), or the like. In some examples, the vehicle 10 includes a camera system 12 which includes an electronic control unit (ECU) 14 connected to a plurality of cameras 16a, 16b, 16c, and 16d. The ECU 14 may include one or more processors programmed to process the images data associated with the cameras 16a-d. Further, as will be described below in more detail, the vehicle 10 includes a plurality of proximity sensors (e.g., ultrasonic sensors) 19. In some examples, the vehicle 10 may include additional types of sensors (e.g., other types of sensors used for an advanced driver assistance system, or ADAS), such as radar, sonar, LiDAR, etc. The proximity sensors 19 may be connected to a designated ECU configured to develop a sensor map of objects external to the vehicle. Alternatively, the proximity sensors can be connected to the ECU 14. As described herein, the cameras 16a-d, the proximity sensors 19, and/or other types of sensors may be referred to as types of detection sensors, some of which (e.g., cameras) may be referred to as image sensors.

The ECUs disclosed herein may more generally be referred to as a controller or processor. In the case of an ECU associated with the proximity sensors 19 in accordance with the principles of the present disclosure, the ECU is configured to receive sensor data from the various proximity sensors (or their respective processors), process the information, and output a sensor map of objects surrounding the vehicle. In this disclosure, the terms “controller,” “module,” and “system” may refer to, be part of, or include processor hardware (shared, dedicated, or group) that executes code and memory hardware (shared, dedicated, or group) that stores code executed by the processor hardware. The code is configured to provide the features of the controller and systems described herein. In one example, the controller may include a processor, memory, and non-volatile storage. The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid-state device, or any other device capable of persistently storing information. The processor may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C #, Objective C, Fortran, Pascal, Java Script, Python, Perl, and PL/SQL. The computer-executable instructions of the programs may be configured to, upon execution by the processor, cause the object classification technique and algorithms described herein.

As shown in FIG. 1A, the vehicle 10 includes eight (8) of the proximity sensors 19, although more than eight of the proximity sensors 19 may be provided. As one example, eighteen (18) or more of the proximity sensors 19 may be provided to capture a 360 degree view of the surroundings of the vehicle. As will be described below in more detail, the ECU 14 is configured to control and activate the proximity sensors 19, receive, record and store data captured by the proximity sensors 19, etc.

In an example, the proximity sensors 19 are implemented using low-cost (e.g., relative to other types of ADAS sensors) and low power consumption ultrasonic sensors configured to continuously monitor the surroundings of the vehicle 10 (e.g., a 360 degree view of the environment around the vehicle 10) when the car is parked, powered off, unattended and/or unoccupied, etc. In an example, each of the proximity sensors 19 is configured to operate at a data acquisition frequency corresponding to 0.4-0.5 watts of power consumption. Accordingly, systems and methods implementing the proximity sensors 19 according to the present disclosure are configured to operate for multiple days while the vehicle 10 is unpowered and not in use (i.e., without drawing significant shore power and/or depleting an energy storage device, such as a battery, of the vehicle 10). As such, these systems and methods can be implemented in an “always on” manner monitor the surroundings of the vehicle 10.

Data generated by the proximity sensors 19 is processed by the ECU 14. For example, the data generated by the proximity sensors 19 (i.e., responsive to objects in the environment detected by the ultrasonic sensors 104) includes sensor distance information (SDI) obtained using one or more free space detection techniques. Generally, SDI may include simple numerical data indicating a distance, in known or predetermined units, between an object and a given sensor. This type of numerical data requires less memory space and other resources and facilitates simple calculation and processing. Further, precise distances of objects, and changes in distances/trajectories of objects relative to the vehicle 10, can be obtained.

Further, physical properties of the proximity sensors 19 (i.e., physical properties of ultrasonic sensors) enable operation in different types of weather conditions such as rain, fog, etc., different times of day/lighting conditions, and so on. For example, since ultrasonic sensors operate using sound waves and sound waves are able to travel through different weather and lighting conditions, systems and methods according to the present disclosure are configured to operate regardless of weather and other environmental conditions, and data obtained by the proximity sensors 19 is accurate/reliable regardless of weather and other environmental conditions.

FIG. 1B shows components of an example system 100 (e.g., as implemented within and/or by the vehicle 10) configured to monitor the surroundings of the vehicle 10 using ultrasonic sensors 104 and a controller 108. For example, the ultrasonic sensors 104 correspond to the proximity sensors 19 of FIG. 1A and the controller 108 corresponds to the ECU 14 of FIG. 1A. The system 100 further includes a power control module or switch 112 and an alert module 116.

The ultrasonic sensors 104 are configured to generate sound signals or waves (e.g., sound wave pulses) and emit the sound waves into the environment around the vehicle. The sensors 104 generate the sound waves at a frequency higher than an audible frequency range, such as in a range of 45 to 55 kHz. The ultrasonic sensors 104 are arranged on (e.g., spaced around) the vehicle to facilitate projection of the sound waves in a manner that provides a 360 degree view of the environment. For example, each of the sensors 104 has a respective coverage area (e.g., a cone-shaped coverage area), and the sensors 104 are spaced such that each coverage area overlaps with adjacent coverage areas. Objects within the coverage areas cause the sound waves to reflect and bounce back towards the sensors 104.

The sensors 104 receive the reflected sound waves (e.g., via an audio input device, such as a microphone or other transducer), which indicate distances between the sensors 104 and the objects. For example, the sensors 104 may be configured to determine an amount of time for the sound waves to travel from the sensors 104 to the objects and back to the sensors from the objects. Distance between the sensors 104 and the objects can then be calculated based on the determined amount of time (e.g., using a known speed of the sound waves at a given temperature). In other examples, the controller 108 may be configured to calculate the distances.

The sensors 104 may be configured to generate the sound waves (e.g., sound wave pulses) and sample reflected sound waves at a given sampling rate or range, such as once every 5-240 ms. The sensors 104 may operate at same or different sampling rates or frequencies. One or more of the sensors 104 may be in a transmit mode (i.e. generating sound waves) will one or more others of the sensors 104 may be in a receive mode (i.e., receiving reflected sound waves). As one example, one of the sensors 104 may be transmitting/generating sound waves while two or more adjacent sensors 104 (e.g., sensors 104 on either side of the transmitting sensor 104) receive the reflected sound waves.

The controller 108 is configured to monitor/track the objects (and movement, trajectories, etc. of the objects) in the environment over time. For example, the controller 108 may be configured to track (e.g., receive, process, and store data indicative of): the number of objects in the environment (e.g., objects within a predetermined range of the vehicle); respective distances between the vehicle and/or sensors 104 and the objects; direction of movement/travel, velocity, and acceleration of the objects relative to the vehicle; angles/trajectories of the objects relative to the vehicle; free space information (e.g., information indicating regions of the environment around the vehicle occupied by and not occupied by objects); whether a direction of movement/trajectory of the object will cause the object to pass within a predetermined distance of the vehicle; and an amount of time an object is within a predetermined distance of the vehicle. As one example, the controller 108 may be configured to generate and store an occupancy grid map of the environment, including objects in the environment and, velocities, trajectories/movement directions, etc. of the objects.

In an example, the controller 108 generates, stores, and updates a motion profile for each of the objects in the environment. The motion profile may indicate, for each object, a current location of the object, a movement path or direction/trajectory, velocity, etc. Based on the motion profile, the controller 108 may determine whether to perform continued surveillance/monitoring of the object. For example, the controller 108 may be configured to calculate a threat score for each object and determine whether to perform continued surveillance for each object based on the threat score (e.g., based on whether the threat score meets or exceeds a threat threshold). In some examples, the controller 108 may calculate and assign threat scores only to dynamic (i.e., moving) objects, and/or assign a threat score of zero (0) to static/stationary objects.

The controller 108 selectively performs one or more actions based on the threat scores. For example, in response to one or more threat scores exceeding the threat threshold (or, in some examples, based on a combined threat score, such an average threat score, exceeding a combined threat score threshold), the controller 108 generates and transmits an alert (e.g., to an owner/driver of the vehicle). For example, the controller 108 sends a signal or command to the alert module 116 indicating that the threat score of at least one surveilled object in the environment exceeds the threat threshold and the alert module 116 transmits an alert accordingly. The alert may be transmitted based on a preferred mode of alert selected by the owner, may be transmitted via two or more alert mechanisms, etc., such as text message, email, cellular call, a smartphone app, etc.

In some examples, the controller 108 is further responsive to the power control module 112. For example, the controller 108 may be configured to control the sensors 104 and perform surveillance and threat score calculation based on one or more conditions and/or determinations, such as a determination of whether the vehicle is powered on or off, a determination of remaining battery charge, an indication of whether the vehicle is coupled to a power source (e.g., whether the battery is connected to a battery charging station), etc. The power control module 112 may receive one or more signals indicative of one or more of the above conditions/determinations and provide a signal to the controller 108 indicating whether to initiate, continue, or stop surveillance of the environment (e.g., whether to activate or deactivate the sensors 104).

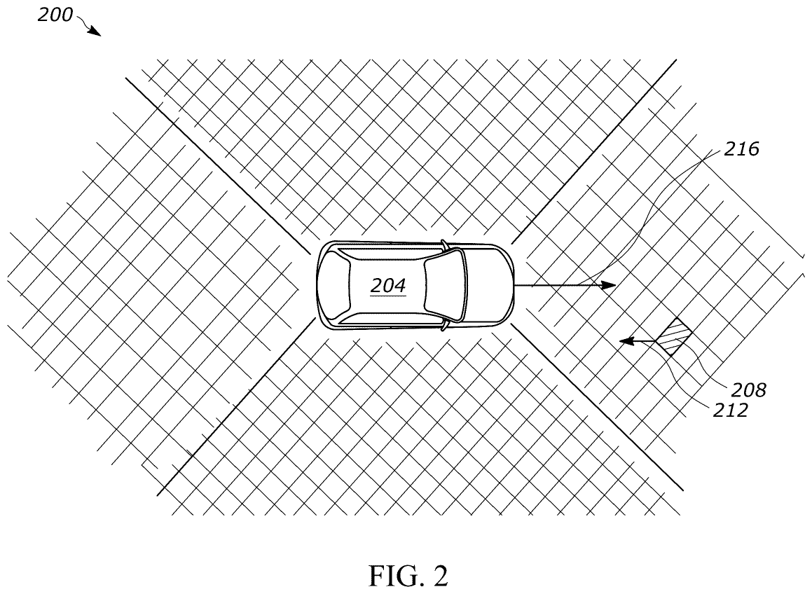

FIG. 2 shows an example occupancy grid map 200 generated by the controller 108. The occupancy grid map 200 includes a vehicle 204 and an object 208 in the environment around the vehicle 204. The occupancy grid map 200 may further includes a direction of movement 212 of the object 208. As shown, the grid map 200 is comprised of a plurality of grid blocks representing the environment/surroundings of the vehicle 204. For example, the grid map 200, grid blocks, the vehicle 204, and the object 208 may be represented by values in an X, Y coordinate system. Distances between the vehicle 204 and the object 208 may be calculated, measured and/or represented in units of grid blocks and/or real-world distance measurements (e.g., meters), converted between grid blocks and real-world distance measurements, etc. Similarly, velocities may be calculated or measured in units of grid blocks and/or real-world distance measurements (e.g., meters per second). Distance in grid block units may be referred to as “free space depth.” Similarly, velocity in grid block units may be referred to as “free space velocity.”

Accordingly, for the object 208 and other objects in the environment, the controller 108 may be configured to calculate a threat score based on various characteristics including, but not limited to: a number of dynamic objects in the environment, a distance between the vehicle 204 and the object 208 (e.g. a free space depth); a velocity of the object 208; and a direction of movement of the object 208. For example, direction of movement may be represented as an angle of the movement direction/trajectory of the object 208 relative to the vehicle 204 (e.g., with a position directly in front of the vehicle, as indicated at 216, corresponding to 90 degrees), and may be represented in units such as radians, degrees, etc.

In some examples, only objects having a threat score above a first threshold Th1 are monitored/surveilled. For example, in response to a determination that the threat score of an object is below the first threshold, the object and/or the threat score of the object are not used in a determination of whether to generate an alert, not used in a combined or composite threat score, etc. Object may also be selectively disregarded or ignored based on various other characteristics, such as movement toward or away from the vehicle 204 (e.g., objects moving away from the vehicle 204 may be ignored), distance from the vehicle 204 (e.g., objects further than a predetermined distance, such as three meters, may be ignore), etc. For objects having thresholds greater than the first threshold (i.e., objects that continue to me monitored), alerts may be generated in response to the threat score exceeding a second threshold Th2 greater than the first threshold Th1.

In one example, the controller 108 calculates the threat score according to: threat score=a*number of dynamic objects detected+b*free space depth+c*velocity+d*direction (angle), where a, b, c, and d are assigned weights (Equation 1). The weights can be predetermined or calibrated, adjusted, etc. Accordingly, in this example, the threat score is calculated based on distance, velocity, and direction of movement of the object, as well as a total number of dynamic objects detected in the environment. As used in Equation 1, the values for number of objects, depth, velocity, and angle may correspond to raw measurements or calculated values and/or assigned values (e.g., calculated values, values obtained from a lookup table, etc.). For example, since a higher threat score indicates a greater calculated threat and potential threat increases as distance decreases, the free space depth value as used in Equation 1 may be a value that increases as the distance between the vehicle 204 and the object 208 decreases. In some examples, the values for the components of Equation 1 may be normalized (e.g., scaled to value in a predetermined range, such as 1-100).

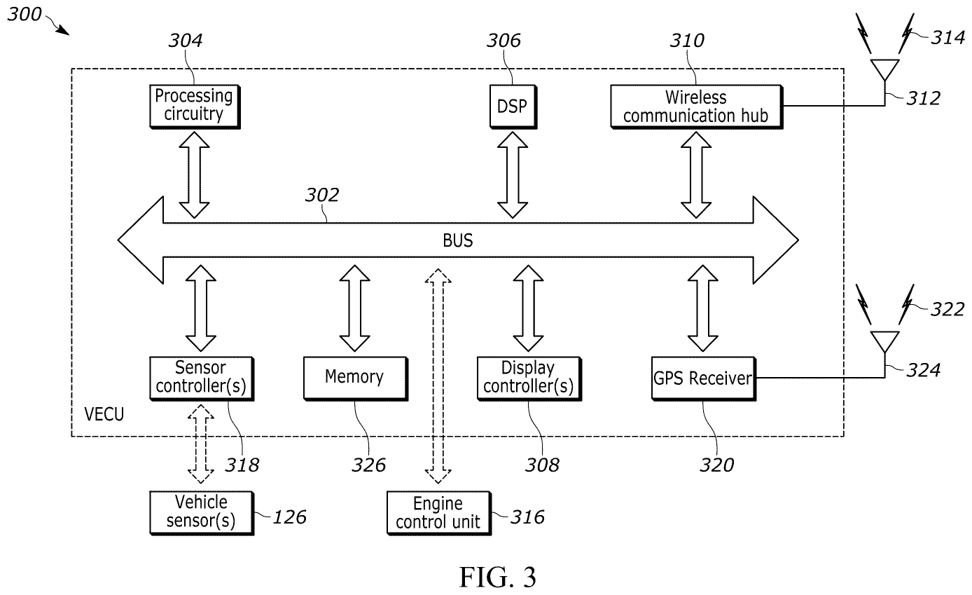

FIG. 3 is a block diagram of internal components of an exemplary embodiment of a computer or computing system 300 configured to implement the systems and methods described above. In this embodiment, the computing system 300 may be embodied at least in part in a vehicle electronics control unit (VECU) or other computing system of a vehicle, such as the vehicles 12 and 204 of FIGS. 1A and 2. It should be noted that FIG. 3 is meant only to provide a generalized illustration of various components, any or all of which may be utilized as appropriate. It can be noted that, in some instances, components illustrated by FIG. 3 can be localized to a single physical device and/or distributed among various networked devices, which may be disposed at different physical locations.

The computing system 300 has hardware elements that can be electrically coupled via a BUS 302. The hardware elements may include processing circuitry 304 which can include, without limitation, one or more processors, one or more special-purpose processors (such as digital signal processing (DSP) chips, graphics acceleration processors, application specific integrated circuits (ASICs), and/or the like), and/or other processing structure or means. The above-described processors can be specially-programmed to perform the operations disclosed herein, including, among others, image processing, data processing, and implementation of the machine learning models described above. Some embodiments may have a separate DSP 306, depending on desired functionality. The computing system 300 can also include one or more display controllers 308, which can control the display devices disclosed above, such as an in-vehicle touch screen, screen of a mobile device, and/or the like.

The computing system 300 may also include a wireless communication hub 310, or connectivity hub, which can include a modem, a network card, an infrared communication device, a wireless communication device, and/or a chipset (such as a Bluetooth device, an IEEE 802.11 device, an IEEE 802.16.4 device, a WiFi device, a WiMax device, cellular communication facilities including 4G, 5G, etc.), and/or the like. The wireless communication hub 310 can permit data to be exchanged with network 114, wireless access points, other computing systems, etc. The communication can be carried out via one or more wireless communication antenna 312 that send and/or receive wireless signals 314.

The computing system 300 can also include or be configured to communicate with an engine control unit 316, or other type of controller 108 described herein. In the case of a vehicle that does not include an internal combustion engine, the engine control unit may instead be a battery control unit or electric drive control unit configured to command propulsion of the vehicle. In response to instructions received via the wireless communications hub 310, the engine control unit 316 can be operated in order to control the movement of the vehicle during, for example, a parking extraction task.

The computing system 300 also includes vehicle sensors 126 such as the ultrasonic sensors 104 described above with reference to FIGS. 1A and 1B. Sensors can include, without limitation, one or more accelerometer(s), gyroscope(s), camera(s), radar(s), LiDAR(s), odometric sensor(s), and ultrasonic sensor(s), as well as magnetometer(s), altimeter(s), microphone(s), proximity sensor(s), light sensor(s), and the like. These sensors can be controlled via associated sensor controller(s) 318.

The computing system 300 may also include a GPS receiver 320 configured to receive signals 322 from one or more GPS satellites using a GPS antenna 324. The GPS receiver 320 can extract a position of the device, using conventional techniques, from satellites of an GPS system, such as a global navigation satellite system (GNSS) (e.g., Global Positioning System (GPS)), Galileo, GLONASS, Compass, Galileo, Beidou and/or other regional systems and/or the like.

The computing system 300 can also include or be in communication with a memory 326. The memory 326 can include, without limitation, local and/or network accessible storage, a disk drive, a drive array, an optical storage device, a solid-state storage device, such as a RAM which can be programmable, flash-updateable and/or the like. Such storage devices may be configured to implement any appropriate data stores, including without limitation, various file systems, database structures, and/or the like. The memory 326 can also include software elements (not shown), including an operating system, device drivers, executable libraries, and/or other code embedded in a computer-readable medium, such as one or more application programs, which may comprise computer programs provided by various embodiments, and/or may be designed to implement methods, and/or configure systems, provided by other embodiments, as described herein. In an aspect, then, such code and/or instructions can be used to configure and/or adapt a general purpose computer (or other device) to perform one or more operations in accordance with the described methods, thereby resulting in a special-purpose computer.

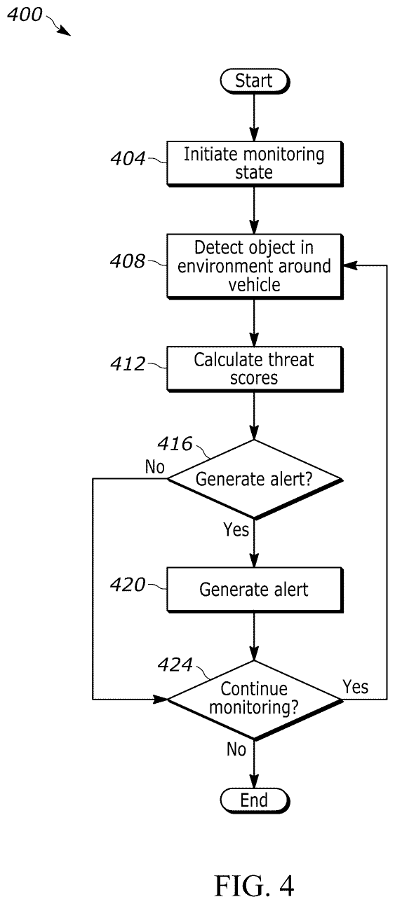

FIG. 4 illustrates steps of an example method 400 for monitoring vehicle surroundings using ultrasonic sensors as described herein. One or more computing devices, controllers, systems, processors or processing devices, circuitry, etc. as described herein may be configured to perform the method 400. For example, a controller such as the controller 108, operating within the system 100, all or portions of which may be implemented within a vehicle, is configured to perform the method 400.

At 404, the method 400 includes selectively initiating/entering a monitoring mode or state. For example, the method 400 initiates the monitoring state in response to a determination that the vehicle is parked or off, unattended, etc. Initiating the monitoring state may include, but is not limited to, activating the ultrasonic sensors and at least a portion of a controller configured to perform monitoring functions as described herein, and may include providing sufficient power to the ultrasonic sensors and the controller to perform relevant functions.

At 408, the method 400 includes detecting, using ultrasonic sensors, objects in the environment around the vehicle as described herein.

At 412, the method 400 includes calculating respective threat scores for the detected objects. For example, the threat scores are calculated in accordance with a*number of dynamic objects detected+b*free space depth+c*velocity+d*direction (angle) as described herein.

At 416, the method 400 includes determining whether to generate an alert based on the threat scores. For example, determining whether to generate the alert includes comparing the threat scores to one or more thresholds as described herein. If true, the method 400 continues to 420. If false, the method 400 continues to 424.

At 420, the method 400 includes generating an alert to alert the owner or driver (or other entity). For example, generating the alert includes causing the alert to be transmitted to the owner via text, email, app notification, etc. as described herein.

At 424, the method 400 includes determining whether to continue monitoring the environment around the vehicle. For exampling, determining whether to continue monitoring (i.e., to continue providing power to the controller and sensors) may include determining whether the vehicle is still powered off and unattended, determining whether the battery or other power source has sufficient power (e.g., has not decreased below a charge threshold), etc. If true, the method 400 continues to 408. If false, the method 400 ends.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. These memory devices may be non-transitory computer-readable storage mediums for storing computer-executable instructions which, when executed by one or more processors described herein, can cause the one or more processors to perform the techniques described herein. The processor and the memory can be supplemented by, or incorporated in, special purpose logic circuitry.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method performed by a controller of a vehicle, the method comprising:
generating and emitting sound signals into an environment around the vehicle using one or more ultrasonic sensors arranged on the vehicle;
receiving, at the one or more ultrasonic sensors, the sound signals as reflected back toward the vehicle by at least one object in the environment;
calculating, at the controller, a threat score associated with the at least one object based on a distance of the object from the vehicle, a velocity of the object, and a direction of movement of the object relative to the vehicle;
comparing, at the controller, the threat score to at least one threshold; and
generating, at the controller, an alert in response to a determination that the threat score is greater than the at least one threshold.

2. The method of claim 1, further comprising, at the controller, selectively activating the one or more ultrasonic sensors in response to determining that at least one of (i) the vehicle is powered off and (ii) the vehicle is unoccupied.

3. The method of claim 1, wherein calculating the threat score includes calculating the threat score further based on a number of moving objects detected within the environment.

4. The method of claim 1, wherein calculating the threat score includes calculating the threat score further based on at least one of:
acceleration of the at least one object relative to the vehicle;
free space information;
a determination of whether the direction of movement of the at least one object will cause the at least one object to pass within a predetermined distance of the vehicle; and
an amount of time an object is within a predetermined distance of the vehicle.

5. The method of claim 1, wherein calculating the threat score associated with the at least one object includes assigning respective values to the distance of the object from the vehicle, the velocity of the object, and the direction of movement of the object relative to the vehicle.

6. The method of claim 5, further comprising assigning respective weights to the respective values.

7. The method of claim 1, wherein the at least one threshold includes a first threshold and a second threshold greater than the first threshold, the method further comprising selectively ignoring the at least one object in response to determining that the threat score is not greater than the first threshold.

8. The method of claim 7, further comprising generating the alert in response to determining that the threat score is greater than the second threshold.

9. A system configured to control and monitor an environment around a vehicle, the system comprising:
one or more ultrasonic sensors arranged on the vehicle, wherein the ultrasonic sensors are configured to (i) generate and emit sound signals into the environment around the vehicle, and (ii) receive, at the one or more ultrasonic sensors, the sound signals as reflected back toward the vehicle by at least one object in the environment; and
a controller configured to
calculate a threat score associated with the at least one object based on a distance of the object from the vehicle, a velocity of the object, and a direction of movement of the object relative to the vehicle,
compare the threat score to at least one threshold, and
selectively generate and transmit an alert in response to a determination that the threat score is greater than the at least one threshold.

10. The system of claim 9, wherein the controller is configured to selectively activate the one or more ultrasonic sensors in response to determining that at least one of (i) the vehicle is powered off and (ii) the vehicle is unoccupied.

11. The system of claim 9, wherein calculating the threat score includes calculating the threat score further based on a number of moving objects detected within the environment.

12. The system of claim 9, wherein calculating the threat score includes calculating the threat score further based on at least one of:
acceleration of the at least one object relative to the vehicle;
free space information;
a determination of whether the direction of movement of the at least one object will cause the at least one object to pass within a predetermined distance of the vehicle; and
an amount of time an object is within a predetermined distance of the vehicle.

13. The system of claim 9, wherein calculating the threat score associated with the at least one object includes assigning respective values to the distance of the object from the vehicle, the velocity of the object, and the direction of movement of the object relative to the vehicle.

14. The system of claim 13, wherein the controller is further configured to assign respective weights to the respective values.

15. The system of claim 9, wherein the at least one threshold includes a first threshold and a second threshold greater than the first threshold, wherein the controller is further configured to selectively ignore the at least one object in response to determining that the threat score is not greater than the first threshold.

16. The system of claim 15, wherein the controller is further configured to generate the alert in response to determining that the threat score is greater than the second threshold.

17. A processor configured to execute instructions stored on a non-transitory computer-readable medium, wherein executing the instructions causes the processor to:
using one or more ultrasonic sensors, generate and emit sound signals into an environment around a vehicle;
receive, at the one or more ultrasonic sensors, the sound signals as reflected back toward the vehicle by at least one object in the environment;
calculate a threat score associated with the at least one object based on a distance of the object from the vehicle, a velocity of the object, and a direction of movement of the object relative to the vehicle;
compare the threat score to at least one threshold; and
selectively generate and transmit an alert in response to a determination that the threat score is greater than the at least one threshold.

18. The processor of claim 17, wherein executing the instructions further causes the processor to selectively activate the one or more ultrasonic sensors in response to determining that at least one of (i) the vehicle is powered off and (ii) the vehicle is unoccupied.

19. The processor of claim 17, wherein calculating the threat score includes calculating the threat score further based on a number of moving objects detected within the environment.

20. The processor of claim 17, wherein calculating the threat score includes calculating the threat score further based on at least one of:
acceleration of the at least one object relative to the vehicle;
free space information;
a determination of whether the direction of movement of the at least one object will cause the at least one object to pass within a predetermined distance of the vehicle; and
an amount of time an object is within a predetermined distance of the vehicle.
